(19) United States
(12) Patent Application Publication
(10) Pub. No.: US 2002/0156999 A1
(43) Pub. Date: Oct. 24, 2002

(54) Mixed-mode hardware multithreading

(75) Inventors: Richard James Eickemeyer, Rochester, MN (US); Harm Peter Hofstee, Austin, TX (US); Charles Roberts Moore, Austin, TX (US); Ravi Nair, Briarcliff Monor, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/838,461

(22) Filed: Apr. 19, 2001

(51) Int. Cl. G06F 9/00

(52) U.S. Cl. 712/228

(57) ABSTRACT

A mixed-mode multithreading processor is provided. In one embodiment, the multi-mode multithreading processor includes a multithreaded register file with a plurality of registers, a thread control unit, and a plurality of hold latches. Each of the hold latches and registers stores data representing a first instruction thread and a second instruction thread. The thread control unit provides thread control signals to each of the hold latches and registers selecting a thread using the data. The thread control unit provides control signals for interleaving multithreading except when a long latency operation is detected in one of the threads. During a predetermined period corresponding approximately to the duration of the long latency operation, the thread control unit places the processor in a mode in which only instructions corresponding to the other thread are read out of the hold latches and registers. Once the predetermined period of time has expired, the processor returns to interleaving multithreading.

### BACKGROUND OF THE INVENTION

1. Technical Field

The present invention relates to an improved data processing system and, more particularly, to hardware multithreading.

2. Description of Related Art

The operating system (OS) software controlling most modern computers enables multitasking. That is, it enables multiple tasks (programs, threads, or processes) to be executed concurrently. On single-processor systems, task execution of multiple programs is typically interleaved to give the appearance of concurrency, whereas on symmetric multiprocessors, a single operating system distributes the various tasks over multiple processors. Even in a symmetric multiprocessor (SMP), the number of tasks can outnumber the number of processors such that multiple tasks must be interleaved on a single processor to give the appearance of concurrency.

Task interleaving under control of the operating system is sometimes referred to as coarse-grain multithreading. Because all the user-level resources must be available to each task, the operating system must save the user-state of a task, such as the values in the registers, to memory, and restore the state of a second task whose execution is to be resumed, on every task switch. When multiple tasks execute on a single processor, the decision to switch tasks is commonly made on the basis of either a timer interrupt (this is called “time-slicing”) or the execution of an operation that is visible to the operating system, such as I/O or a translation miss, by the task that is running.

On a multithreaded processor, the state of more than one thread is available in the registers of the processor. This has the advantage that a task switch can occur without requiring all the state in the processor's architectural registers to be saved in memory first, and hence a thread switch can occur with little overhead. Three types of hardware multithreaded processors are known.

1.) Interleaved multithreaded processors, such as used in the TERA computer. In this case, in cycle n, instructions from thread n mod m, where m is the number of simultaneously executing threads, are issued.

2.) Hardware multithreaded processors, such as the IBM Northstar AS-400 series processor. In this processor the hardware switches between two threads based on lower-level events, such as a cache miss.

3.) Simultaneous multithreading, in which instructions from multiple threads are issued in the same cycle.

Method 1.) has the disadvantage that issue slots go unused if one of the threads is idle. Method 2.) has the disadvantage that issue slots are poorly utilized by a single thread because of dependencies between instructions. This disadvantage is especially significant in deeply pipelined processors. Method 3.) has the disadvantage that all registers of all threads must be accessible at all times, hence register files in SMT architectures tend to be large and slow.

It would therefore be desirable to have a new type of mixed-mode multithreading that does not suffer from these disadvantages.

### SUMMARY OF THE INVENTION

The present invention provides a mixed-mode multithreading processor. In one embodiment, the multi-mode multithreading processor includes a multithreaded register file with a plurality of registers, a thread control unit, and a plurality of hold latches. Each of the hold latches and registers stores data representing a first instruction thread and a second instruction thread. The thread control unit provides thread control signals to each of the hold latches and registers selecting a thread using the data. The thread control unit provides control signals for interleaving multithreading except when a long latency operation is detected in one of the threads. During a predetermined period corresponding approximately to the duration of the long latency operation, the thread control unit places the processor in a mode in which only instructions corresponding to the other thread are read out of the hold latches and registers. Once the predetermined period of time has expired, the processor returns to interleaving multithreading.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a data processing system in which the present invention may be implemented in accordance with a preferred embodiment of the present invention;

FIG. 2 depicts a block diagram of a basic reduced instruction set chip (RISC) processor in accordance with the present invention;

FIG. 3 depicts a block diagram of a thread control system in accordance with the present invention;

FIG. 4 depicts a flowchart illustrating an exemplary process for selecting multithreading modes for a state holding register in accordance with the present invention; and

FIG. 5 depicts a flowchart illustrating an exemplary control for a state holding register.

### DETAILED DESCRIPTION OF THE PREFERRED EMBODIMENT

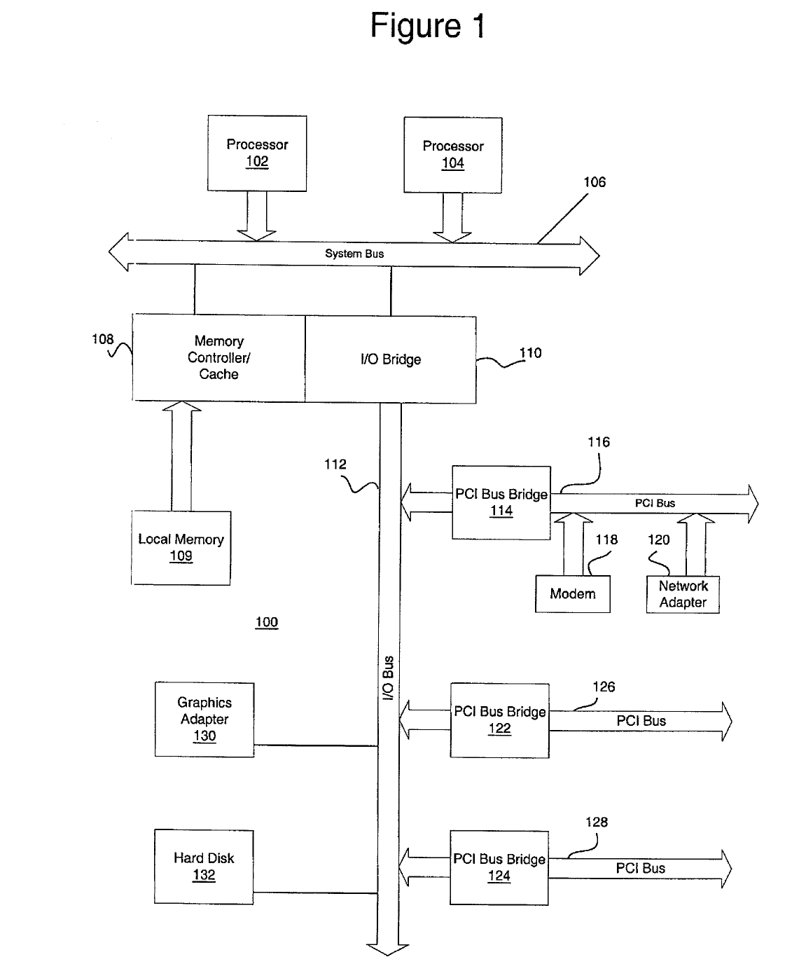

Referring to FIG. 1, a block diagram of a data processing system in which the present invention may be implemented is depicted in accordance with a preferred embodiment of the present invention. Data processing system 100 may be a symmetric multiprocessor (SMP) system including a plurality of processors 102 and 104 connected to system bus 106. Alternatively, a single processor system may be employed. Also connected to system bus 106 is memory controller/cache 108, which provides an interface to local memory 109. I/O bus bridge 110 is connected to system bus 106 and provides an interface to I/O bus 112. Memory controller/cache 108 and I/O bus bridge 110 may be integrated as depicted.

Peripheral component interconnect (PCI) bus bridge 114 connected to I/O bus 112 provides an interface to PCI local bus 116. A number of modems may be connected to PCI bus 116. Typical PCI bus implementations will support multiple PCI expansion slots or add-in connectors. Communications links to network computers 108-112 in FIG. 1 may be provided through modem 118 and network adapter 120 connected to PCI local bus 116 through add-in boards.

Additional PCI bus bridges 122 and 124 provide interfaces for additional PCI buses 126 and 128, from which additional modems or network adapters may be supported. In this manner, data processing system 100 allows connections to multiple network computers. A memory-mapped graphics adapter 130 and hard disk 132 may also be connected to I/O bus 112 as depicted, either directly or indirectly.

Each of processors 102 and 104 supports multithreading. Multithreading is multitasking within a single program.

Certain types of applications lend themselves to multithreading. For example, in an order processing system, each order can be entered independently of the other orders. In an image editing program, a calculation-intensive filter can be performed on one image, while the user works on another. In a symmetric multiprocessing (SMP) operating system as depicted, its multithreading allows multiple processors 102 and 104 to be controlled at the same time. Multithreading is also used to create synchronized audio and video applications.

To allow multithreading on each processor 102 and 104, each processor 102 and 104 contains a plurality of latches as will be recognized by one skilled in the art. The latches within the processors 102 and 104 are of two types: flow-through and hold state. Flow-through latches are latches that are used to break multiple-cycle paths into distinct stages, but in which the same data is not held for multiple cycles, and are implemented unchanged from the prior art. Hold state latches are latches that store bits of data until needed by other components within the processor. The hold state latches in the present invention are modified from the prior art to store two bits rather than one bit with select signals corresponding to the thread determining which state is read.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 1 may be, for example, an IBM RISC/System 6000 system, a product of International Business Machines Corporation in Armonk, N.Y., running the Advanced Interactive Executive (AIX) operating system.

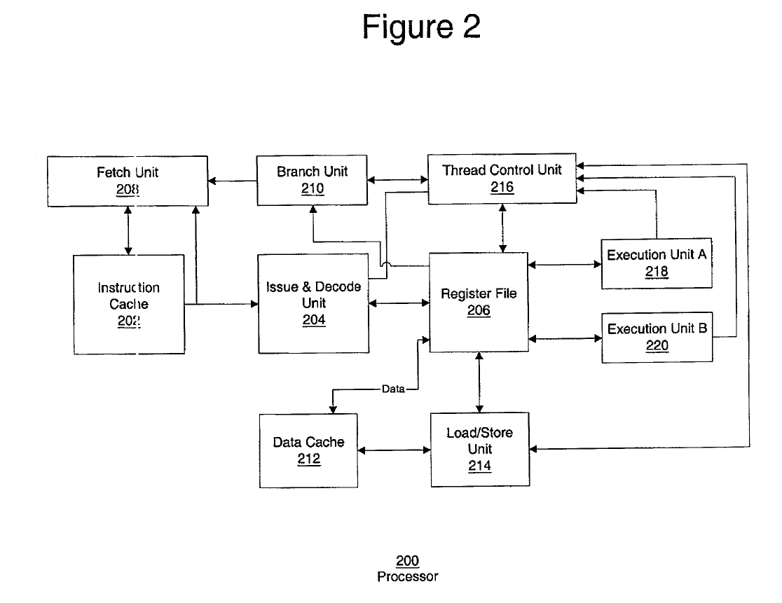

With reference now to FIG. 2, a block diagram of a basic reduced instruction set chip (RISC) processor is depicted in accordance with the present invention. Processor 200 may be implemented as, for example, either of processors 102 and 104 in FIG. 1. Processor 200 is an example of a processor capable of dual mode multithreading (i.e. both “TERA Computer” and “AS/400 Star Series” type multithreading). “TERA Computer” multithreading mode is a type of multithreading in which instructions from the different threads strictly alternate. “AS/400 Star Series” type multithreading is a type of multithreading in which a thread switch occurs in response to a long latency period, such as, for example, a load instruction that misses in the datacache.

Processor 200 includes a fetch unit 208 which retrieves and loads instructions to be executed by processor 200 from instruction cache 202. Instruction cache 202 holds instructions from both threads executed by processor 200. Branch unit 210 allows instructions to be fetched in advance in response to receipt of a special branch instruction. Issue and decode unit 204 interprets and implements instructions received from instruction cache 202. Data cache 212 stores data corresponding to both threads received from load/store unit 214 which loads data into processor 200.

Multithread register file 206 contains multiple registers that each hold architectural states from both threads. Execution unit A 218 and execution unit B 220 execute the microcode instructions for the appropriate thread read out of multithread register file 206 and appropriate hold latches (not shown) based on thread control signals from the thread control unit 216.

Thread control unit 216 controls the active signals for the different threads depending on whether a long-latency operation has occurred in that thread. Thus, if a long latency occurs in one thread, the thread selection signals for that thread can be set to inactive and the mode of operation switched to execute only the instructions for the other thread until a period of time has elapsed sufficient that the inactive thread is ready to continue. This period of time may be a predetermined predicted period of time based on the type of operation causing the latency. This predetermined period of time is the time predicted to be sufficient to allow the operation that has resulted in the latency to complete. The thread selection signals flow through the pipeline with the instruction and are typically applied to the latches delayed by one or multiple cycles from the control signal applied to the register file.

It should be noted that processor 200 is given merely as an example and not as an architectural limitation. For example, processor 200 may include more execution units that depicted in FIG. 2.

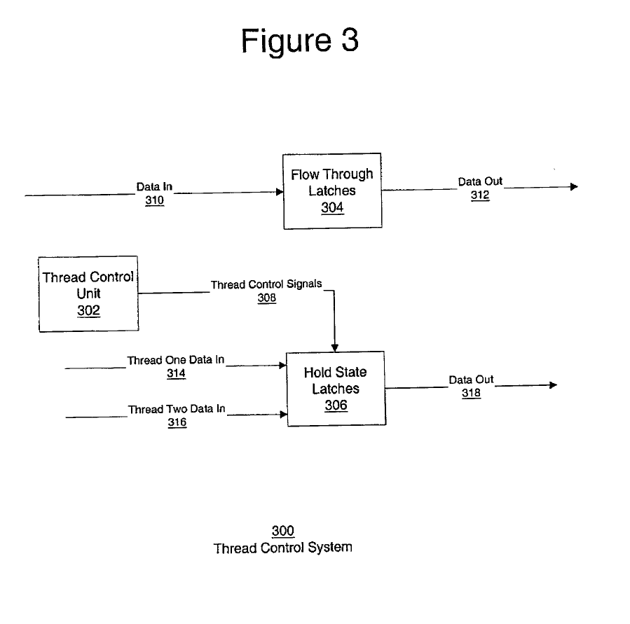

With reference now to FIG. 3, a block diagram of a thread control system is depicted in accordance with the present invention. Thread control system 300 may be implemented in a processor, such as, processor 200 in FIG. 2, that is capable of both “TERA Computer” and “AS/400 Star Series” type multithreading. As discussed above, “TERA Computer” multithreading mode is a type of multithreading in which instructions from the different threads strictly alternate. “AS/400 Star Series” type multithreading is a type of multithreading in which a thread switch occurs in response to a long latency period, such as, for example, a load instruction that misses in the datacache. Thread control system 300 combines both types of multithreading to gain a performance advantage in data processing systems at a minimal design and area penalty.

Thread control system 300 includes a thread control unit 302, a plurality of hold state latches 306, and a plurality of flow through latches 304 as well as other components not shown for simplicity. Flow through latches 304 each contain an input for data in signals 310 and an output for data out signals 312 originating and ending in other components (not shown) within the data processing system. Flow through latches 304 perform in the same fashion as flow through latches in prior art processors and are not required to be modified in any manner from the prior art. Hold state latches 306, however, are modified from the prior art. In the prior art, the hold state latches store a single bit. In the present invention, hold state latches 306 store two bits. Thus, hold state latches 306 include two data inputs for receiving thread one data in signals 314 and thread two data in signals 316 and also includes an output for data out signals 318. Hold state latches 306 also include a control input for receiving thread control signals 308 from thread control unit 302.

Thread control signals 308 determine which of the two state stored in hold state latches 306 are output as data out 318 from hold state latches 306. When the processor is operating in interleaved mode (i.e. “TERA Computer” type multithreading), thread control signals 308 strictly alternate, allowing first thread one and then thread two signals to be processed. This strict alternation allows signals to be computed multiple cycles in advance, hence all cycles are utilized.

When a long latency operation, such as a load instruction that misses in the data cache or a mispredicted branch, in one of the threads is detected by thread control unit 302, thread control unit 302 responds by skipping the control signals corresponding to that thread for a number of cycles determined by the predicted latency of the operation that is detected. Thus, during a long latency, thread control system 300 is switched from “TERA Computer” type multithreading to “AS/400 Star Series” type multithreading, thereby gaining a performance advantage over prior art processors. The cost of implementing the multithreading processor according to the present invention is much smaller than simultaneous multithreading (SMT) approaches that dynamically assign issue slots to the participating threads. Every clock cycle in the processor corresponds to an instruction issue slot and multiple instructions may be issued in a single cycle.

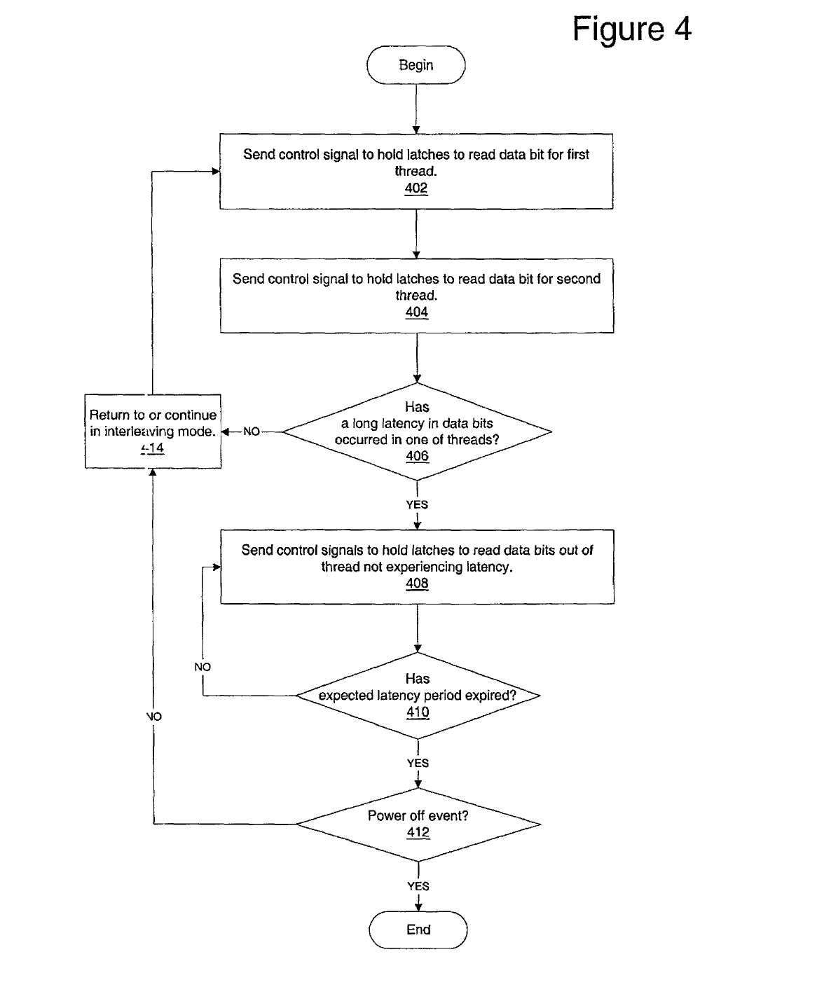

With reference now to FIG. 4, a flowchart illustrating an exemplary process for selecting multithreading modes for a processor, such as, for example, processor 102 or 104 in FIG. 1, is depicted in accordance with the present invention. The present process may be implemented in, for example, thread control unit 302 in FIG. 3. To begin, the thread control unit sends signals to each hold latch to read the data bit corresponding to the first thread (step 402). The thread control unit then sends control signals to the hold latches to read the data bit for the second thread (step 404). During this process of reading first one and then the other thread, the thread control unit determines whether a long latency in data bits has occurred for one of the other threads (step 406). If no latency has occurred, then the control unit continues in interleaving mode (step 414) by returning to step 402.

If a long latency has occurred in the data bits of one of the threads, then the thread control unit sends control signals to the hold latches to read the data bits out of the thread not experiencing a latency (step 408). This continues until the thread control unit determines that the expected latency period has expired (step 410). The expected latency period may be determined, for example, by determining the type of operation that is currently being implemented in the thread with a predetermined expected value for the time necessary to complete that type of operation. Once the latency period has expired and no power off event has occurred (step 412), the thread control unit returns to interleaving mode (step 414). It is important to note that in a pipelined implementation, that the alternating selection of the register bit should be synchronized with the instruction issued.

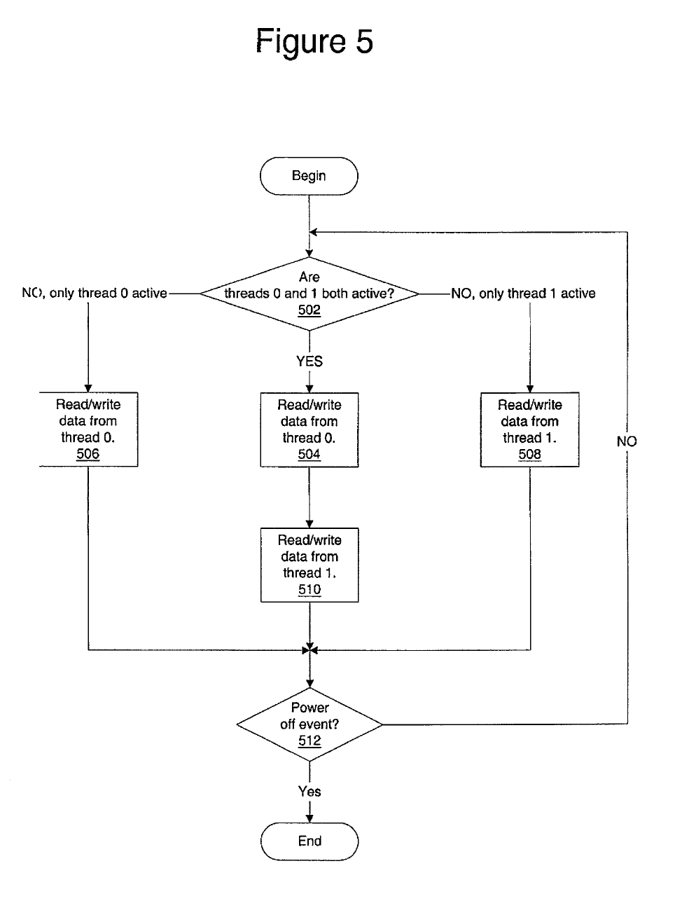

With reference now to FIG. 5, a flowchart illustrating an exemplary control for a state holding register is depicted in accordance with the present invention. To begin, a thread control unit determines whether both threads 0 and 1 are active (step 502). Initially, control signals for both threads are set to active and are set to inactive for a predetermined amount of time on a long-latency operation with the predetermined amount of time depending on the type of operation detected. Thus, if both threads 0 and 1 are active, the latch is instructed to read (or write as the case may be) data from thread 0 (step 504) and then read (or write as the case may be) data from thread 1 (step 510). It is then determined whether a power off event has occurred (step 512) and if so, the process ends. If not, then the process returns to step 402.

If it is determined that only thread 0 is active, then the latch reads (or writes) data from thread 0 (step 506) and then continues with step 512. If it is determined that only thread 1 is active, then the latch reads (or writes) data from thread 1 (step 508) and then continues with step 512. Therefore, efficient use of the processor's resources is maintained by switching between the two types of multithreading. Thus, when a long latency occurs in one thread, execution of the other thread is not slowed down.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A multithreading processor, comprising:
a thread control unit;
a multithreaded register file having a plurality of registers; and
a plurality of hold latches, wherein
each of a plurality of the registers in the multithreaded register file and each of a plurality of the hold latches stores data representing a first instruction thread and a second instruction thread; and
the thread control unit provides a thread control signal to said hold latches and registers selecting a thread using said data.

2. The multithreading processor as recited in claim 1, wherein the thread control unit via the thread control signal places at least one of the plurality of the hold latches and at least one of the plurality of the register files into an interleaving multithreading mode.

3. The multithreading processor as recited in claim 1, wherein the thread control unit, responsive to a determination that a latency in an instruction exceeding a first predetermined time has occurred in one of the two threads, sends control signals to said hold latches and register files for reading out data exclusively from the other of the two threads until a second predetermined time has elapsed.

4. The multithreading processor as recited in claim 3, wherein the thread control unit returns the plurality of hold latches and register files to an interleaving multithreading mode after the expiration of the second time period.

5. The multithreading processor as recited in claim 3, wherein the latency in an instruction exceeding a first predetermined time results from a load instruction that misses in a datacache.

6. The multithreading processor as recited in claim 3, wherein the latency in an instruction exceeding a first predetermined time results from a mispredicted branch.

7. A data processing system, comprising:
a memory unit;
a mixed-mode multithreading processor; and
a bus coupling the multimedia multithreading processor; wherein
the multimedia multithreading processor comprises:
a thread control unit;
a multithreaded register file having a plurality of registers; and
a plurality of hold latches; wherein
each of a plurality of the registers in the multithreaded register file and each of a plurality of the hold latches stores data representing a first instruction thread and a second instruction thread; and
the thread control unit provides thread control signals to said hold latches and registers selecting a thread using said data.

8. The data processing system as recited in claim 7, wherein the thread control unit via the thread control signal places at least one of the plurality of the hold latches and at least one of the plurality of the registers into an interleaving multithreading mode.

9. The data processing system as recited in claim 7, wherein the thread control unit, responsive to a determination that a latency in an instruction exceeding a first predetermined time has occurred in one of the two threads, sends control signals to said hold latches and registers for reading out data exclusively from the other of the two threads until a second predetermined time has elapsed.

10. The data processing system as recited in claim 9, wherein the thread control unit returns said hold latches and registers to an interleaving multithreading mode after the expiration of the second time period.

11. The data processing system as recited in claim 9, wherein the latency in an instruction exceeding a first predetermined time results from a load instruction that misses in a datacache.

12. The data processing system as recited in claim 9, wherein the latency in an instruction exceeding a first predetermined time results from a mispredicted branch.

13. The data processing system as recited in claim 7, wherein the multimedia multithreading processor is a first multimedia multithreading processor, the thread control unit is a first thread control unit, the hold latches are first hold latches, the multithreaded register file is a first multithreaded register file, the plurality of registers are a plurality of first registers, and the data is a first data, and further comprising:
a second multimedia multithreading processor, wherein the second multimedia multithreading processor comprises:
a second thread control unit;
a second multithreaded register file having a plurality of second registers; and
a plurality of second hold latches, wherein
each of a plurality of the second registers and each of a plurality of the second hold latches stores second data representing a third instruction thread and a fourth instruction thread; and
the second thread control unit provides second thread control signals to said second hold latches and second registers selecting a thread using said second data.

14. A processor for use in a data processing system, the processor comprising:
a plurality of flow through latches; and
a plurality of hold state latches, wherein
the hold state latches store two data units, with one data unit corresponding to a first thread and a second data unit corresponding to a second thread, and
control signals determine which of the two data units is read out of each of the plurality hold state latches.

15. The processor as recited in claim 14, wherein, responsive to a determination that one thread is not active, reading data corresponding to only one of the threads for a period of time.

16. The processor as recited in claim 15, wherein the period of time is a predetermined amount of time corresponding to a predicted latency in the one thread that is not active.

17. A data processing system, comprising:
a memory unit;
a mixed-mode multithreading processor; and
a bus coupling the multimedia multithreading processor; wherein
the multimedia multithreading processor comprises:
a plurality of flow through latches; and
a plurality of hold state latches, wherein the hold state latches store two data units, with one data unit corresponding to a first thread and a second data unit corresponding to a second thread, and
control signals determine which of the two data units is read out of each of the plurality hold state latches.

18. The data processing system as recited in claim 17, wherein, responsive to a determination that one thread is not active, reading data corresponding to only one of the threads for a period of time.

19. The data processing system as recited in claim 18, wherein the period of time is a predetermined amount of time corresponding to a predicted latency in the one thread that is not active.
